(19) United States
(12) Patent Application Publication
(10) Pub. No.: US 2008/0102771 A1
(43) Pub. Date: May 1, 2008

(54) METHOD AND SYSTEM FOR PROVIDING SERVICE IN A NETWORK

(75) Inventors: Pranavkumar L. Joshi, Schaumburg, IL (US); John M. Harris, Chicago, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/554,613

(22) Filed: Oct. 31, 2006

(51) Int. Cl. H04B 1/18

(52) U.S. Cl. 455/187.1

(57) ABSTRACT

A method (300) and a network device (112) for providing a service in a network (100) are disclosed. The network includes an originator device, a network device and one or more target devices. The method includes receiving (304) a request from the originator device for initiating the service with the one or more target devices. Further, the method includes identifying (306) one or more specific initial ranging codes associated with each of the one or more target devices. Furthermore, the method includes transmitting (308) a paging message to each of the one or more target devices in response to the request made by the originator device. Moreover, the method includes transmitting (310) a service signal to the originator device based on response of the one or more target devices within a predefined time interval.

### FIELD OF THE INVENTION

This invention relates in general to networks, and more specifically, to providing a service in a network.

### BACKGROUND OF THE INVENTION

With the increased use of communication devices such as cellular phones, laptops, Personal Digital Assistants (PDAs), and messaging devices, as well as technological enhancements in the field of wireless communications, many new services such as Push-To-Talk (PTT) have entered the market. In a conventional PTT service, a user of an originator communication device can initiate a PTT call with a target communication device by pressing a button on the originator communication device. Further, after the PTT call has been initiated by the originator communication device, a network device establishes a connection with the target communication device. In many cases, once the connection with the target communication device has been established, the network device transmits a signal, for example, a Talk Permit Tone (TPT), to the user of the originator communication device. The TPT can be used to notify the user of the originator device that the connection with the target device has been established. Consequently, the user of the originator communication device can start talking.

However, for various reasons, for example, network congestion due to communication traffic or while establishing the traffic channel, there might be a delay in transmitting the TPT to the originator communication device. Delay in transmitting the TPT can lead to unnecessary delay in the PTT communication. Further, this would also require the user of the originator communication device to keep the PTT button pressed for a longer duration of time till a TPT is received.

Conventional PTT systems reduce the delay in transmitting the TPT by transmitting the TPT even when a connection with the target communication device has not been completely established. The TPT might be available to the user of the originator communication device even before the connection has been established. Transmitting a ‘false’ TPT without establishing a connection is termed as ‘falsing’. Falsing can lead to loss of communication when the user of the originator communication device starts talking even when the connection for PTT is not established as it is more likely that the user will not be possible to establish a channel to the target.

In light of the above, there is a need for a method and system for providing a service in a network which requires less time to transmit a TPT. Further, the system should also prevent falsing. Furthermore, the system should prevent loss of communication.

### BRIEF DESCRIPTION OF DRAWINGS

The accompanying figures, where like reference numerals refer to identical or functionally similar elements throughout the separate views, and which, together with the detailed description below, are incorporated in and form part of the specification, serve to further illustrate various embodiments and to explain various principles and advantages, all in accordance with the present invention.

FIG. 1 illustrates an exemplary network, in accordance with some embodiments of the present invention;

FIG. 2 illustrates a block diagram of cells in an exemplary network, in accordance with an embodiment of the present invention;

FIG. 3 is a flow diagram illustrating a method for providing a service in a network, in accordance with an embodiment of the present invention; and

FIG. 4 illustrates a block diagram of a network device, in accordance with some embodiments of the present invention.

### DETAILED DESCRIPTION

For one embodiment, a method for providing a service in a network is provided. The network includes an originator device, a network device, and one or more target devices. The method includes receiving a request from the originator device for initiating the service with one or more target devices. Further, the method includes identifying one or more specific initial ranging codes for the one or more target devices. Each of the one or more specific initial ranging codes is associated with each of the one or more target devices. The identification of one or more specific initial ranging codes is performed when at least one of the following conditions is true: a load value of the network is less than a predefined value; a previous location information and a probable location information of the one or more target devices is known; a target device of the one or more target devices is invited for the service in which the target device is a required participant; and the one or more target devices are invited for the service in which response of at least one of the one or more target devices is sufficient to initiate the service. Moreover, the method includes transmitting a paging message to each of the one or more target devices in response to the request made by the originator device. Furthermore, the method includes transmitting a service signal to the originator device based on response of the one or more target devices to the paging message within a first predefined time interval.

For another embodiment, a network device is provided. The network device includes a request receiver for receiving a request for initiating a service from an originator device. Further, the network device includes a code selector for identifying one or more specific initial ranging codes for one or more target devices. Further, each of the one or more initial ranging codes is associated with each of the one or more target devices. The code selector identifies the one or more specific initial ranging codes when at least one of the following conditions is true: a load value of the network is less than a predefined value; a previous location information and a probable location information of the one or more target devices is known; a target device of the one or more target devices is invited for the service in which the target device is a required participant; and the one or more target devices are invited for the service in which response of at least one of the one or more target devices is sufficient to initiate the service. Further, the network device includes a paging message transmitter for transmitting a paging message to each of the one or more target devices in response to the request made by the originator device. Moreover, the network device includes a service signal transmitter for transmitting a service signal to the originator device based on response of the one or more target devices to the paging message within a first predefined time interval.

Before describing in detail the particular method and system for providing a service in a network in accordance with various embodiments of the present invention, it should be observed that the present invention utilizes a combination of method steps and apparatus components related to the method and system for providing a service in a network. Accordingly, the apparatus components and method steps have been represented where appropriate by conventional symbols in the drawings, showing only those specific details that are pertinent for an understanding of the present invention so as not to obscure the disclosure with details that will be readily apparent to those with ordinary skill in the art having the benefit of the description herein.

In this document, the terms ‘comprises,’ ‘comprising,’ ‘includes,’ ‘including,’ or any other variation thereof, are intended to cover a non-exclusive inclusion, such that a process, article, system or apparatus that comprises a list of elements does not include only those elements but may include other elements not expressly listed or inherent to such process, article, or apparatus. An element preceded by ‘comprises . . . a’ does not, without more constraints, preclude the existence of additional identical elements in the process, article, system, or apparatus that comprises the element. The terms “includes” and/or “having”, as used herein, are defined as comprising.

The term “another,” as used in this document, is defined as at least a second or more. The term “includes” as used herein, are defined as comprising.

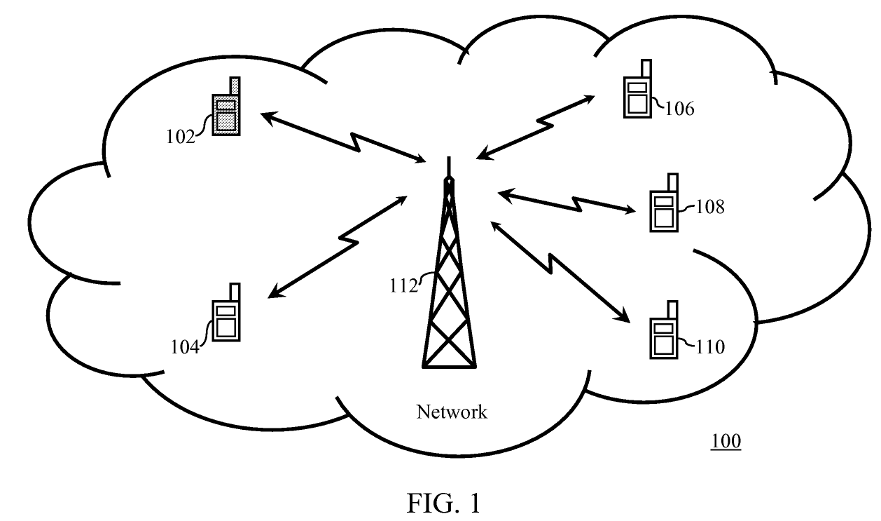

FIG. 1 illustrates an exemplary network 100, in accordance with some embodiments of the present invention. Examples of the network 100 can include, but are not limited to, IEEE 802.16-based broadband wireless access networks, Advanced Mobile Phone Systems (AMPS) networks, Global System for Mobile Communications (GSM) networks, Digital Cellular Systems (DCS) networks, IEEE 802.16e/j/m, Third Generation Partnership Project (3GPP) phase 2, 3GPP2 LTE, and Universal Mobile Telecommunication Systems (UMTS) networks. The network 100 can include a client device 102, a client device 104, a client device 106, a client device 108, and a client device 110. Examples of the client devices 102, 104, 106, 108, and 110 can include, but are not limited to, cellular phones, laptops, Personal Digital Assistants (PDAs) and messaging devices. Further, the network 100 can include a network device 112. Examples of the network device 112 can include, but are not limited to, an application server and a Base Transceiver Station (BTS).

For one embodiment, a client device in the network 100 can request the network device 112 to establish a service with one or more client device. Examples of the service can include, but are not limited to, a Push-To-Talk service (PTT) and network gaming service. In this embodiment, the client device requesting the network device 112 to establish the service can be referred to as an originator device. Further, the one or more client devices with which the originator device wants to establish the service can be referred to as target devices. Each of the client devices 102, 104, 106, 108, and 110 in the network 100 can act as either an originator device or a target device. Further, it would be apparent to those skilled in the art that any client device in the network 100 can act as an originator device and can request the network device 112 for initiating the service with one or more client devices. Moreover, it would be apparent to those skilled in the art that any client device in the network 100 can act as a target device to establish a service with the network device 112. However, for the sake of clarity, the present invention can be explained in conjunction with the client device 102 as the originator device, and one or more of the client devices 104, 106, 108, and 110 as target devices in the following description.

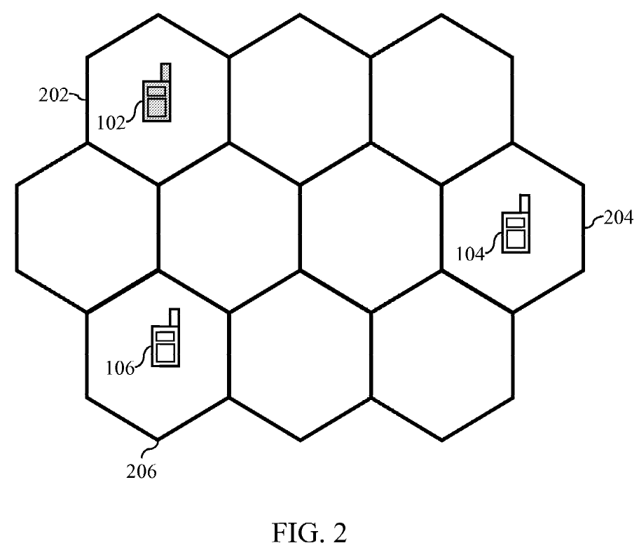

FIG. 2 illustrates a block diagram of cells in the network 100, in accordance with an embodiment of the present invention. For one embodiment, the network 100 can include a plurality of cells. Each of the plurality of cells can include a network device, for example, a Base Transceiver Station (BTS). For one embodiment, a first client device and a second client device can be present in a cell 202. Further, the first client device can send a request to a BTS of the cell 202 for initiating a service, for example, a Push-To-Talk (PTT) call, with the second client device. For one embodiment, the BTS can store one or more specific initial ranging codes associated with various client devices for setting up a PTT service.

On receiving the request for the PTT service, the BTS of the cell 202 can identify one or more specific initial ranging codes associated with the second client device. For one embodiment, the one or more specific initial ranging codes can be reserved for the second client device. Each of the one or more specific initial ranging codes can have a specific interpretation. For example, specific initial ranging codes ‘118’ and ‘011’ can be reserved for the second client device. Further, the specific interpretation of the pre-assigned initial ranging code ‘118’ can be, for example, forwarding the PTT call to another client device and the specific interpretation of the pre-assigned initial ranging code ‘011’ can be, for example, accepting the call. Further, the BTS of the cell 202 can send a paging message to the second client device to communicate the one or more specific initial ranging codes to the second client device. For one embodiment, the one or more specific initial ranging codes associated with the second client device can be embedded in the paging message along with other information and sent to the second client device. The other information can be, for example, location update information.

Further, the one or more specific initial ranging codes can be sent, for example, after every second predefined time interval, till the second client device sends a response, using the one or more specific initial ranging codes to the BTS. The second client device can respond to the paging message sent by the BTS by selecting a specific initial ranging code of the one or more specific initial ranging codes, to send a response to the BTS of the cell 202. Further, the second client device can respond using a specific initial ranging code based on the specific interpretation of the specific initial ranging code. For example, the second client device can reply to the paging message sent by the BTS by using the specific initial ranging code ‘011’, to accept the PTT invitation sent by the first client device. Further, when the BTS receives the response of the second client device for accepting the PTT invitation, the BTS can transmit a service signal, for example, a Talk-Permit-Tone (TPT), to the first client device. On receiving the TPT, a user operating the first client device can be notified that a user of the second client device has accepted the invitation for the PTT service and is ready to talk. The user of the first client device can start talking once the TPT has been transmitted to the first client device. For one embodiment, the second communication device may not send any response to the PTT service paging message sent by the BTS. In this embodiment, a no response signal is transmitted by the BTS to the first client device. On receiving the no-response signal, the user of the first client device can be notified that the user of the second client device is not ready to accept the invitation for the PTT service.

For one embodiment, an originator client device, for example, the client device 102 can be in the cell 202, and a target client device, for example, the client device 104, can be in cell 204. Further, another target device, for example, the client device 106, can be in cell 206. The client device 102 can send a request to the BTS of the cell 202 for initiating the PTT call with the client devices 104 and 106. On receiving the request for the PTT, the BTS of the cell 202 can interact with BTS of the cell 204 and BTS of the cell 206 to communicate the request for the PTT to their respective client devices.

For one embodiment, the BTS of the cell 202 can identify one or more specific initial ranging codes for the client devices 104 and 106. For another embodiment, the BTS of the cell 204 can identify the one or more specific initial ranging codes for the client device 104 and the BTS of the cell 206 can identify the one or more specific initial ranging codes for the client device 106. Further, the BTS of cell 204 can send a paging message having one or more specific initial ranging codes to the client device 104. Similarly, the BTS of the cell 206 can send a paging message having one or more specific initial ranging codes to the client device 106.

For one embodiment, the one or more specific initial ranging codes associated with the client devices 104 and 106 can be embedded in the paging message and sent to the client devices 104 and 106. In this embodiment, the one or more specific initial ranging codes can be sent after every second predefined time interval, till a response is received. The second predefined time interval can be set by, for example, a provider of the service. For another embodiment, one or more groups of specific initial ranging codes are embedded in the paging message and sent to the client devices 104 and 106 only once. Further, each of the specific initial ranging codes of the one or more group of specific initial ranging code can have a specific interpretation. In this embodiment, a different subset of the one or more group of specific initial ranging codes sent to the client devices 104 and 106 is used for a different time-slot. For example, the client device 106 can be assigned a group of specific initial ranging codes having specific initial ranging codes as ‘01’, ‘00’, ‘11’, ‘10’, ‘111’, and ‘110’. Further, each of these codes can have a specific interpretation. For example, the specific interpretation of the specific initial ranging code ‘01’ can be forwarding the PTT call to another client device. The specific interpretation of the specific initial ranging code ‘00’ can be rejecting the PTT call. Further, the specific interpretation of the specific initial ranging code ‘11’ can be accepting the PTT call and the specific interpretation of the specific initial ranging code ‘10’ can be transferring the PTT call to an answering machine. Further, the client device 106 can use the specific initial ranging codes ‘01’, ‘00’, ‘11’, and ‘10’, if the client device 106 responds within, say, 10 seconds. However, if the client device 106 is not able to respond within 10 seconds, the client device 106 use the specific initial ranging codes ‘111’ and ‘110’. The specific interpretation of the specific initial ranging code ‘111’ can be, for example, accepting the PTT call and the specific interpretation of the specific initial ranging code ‘110’ can be, for example, rejecting the PTT call. Further, in this embodiment, the number of specific initial ranging codes available to the client device 106 to respond to the PTT call invitation reduces after every 10 seconds.

The client devices 104 and 106 can respond to the paging message by using a specific initial ranging code of the one or more specific initial ranging codes associated with each of the client devices 104 and 106. The specific initial ranging code used by a client device, for example, the client device 104 can be based on the specific interpretation of the specific initial ranging code and way the client device 104 wants to respond to the request for establishing the PTT call. Further, on receiving a response from the client devices, the BTS of the cell 202 can send a Talk-Permit-Tone (TPT) to the client device 102 if the client devices 104 and/or 106 accept the PTT call. The TPT can be used to notify to a user of the client device 102 that the PTT service with the target client devices has been established.

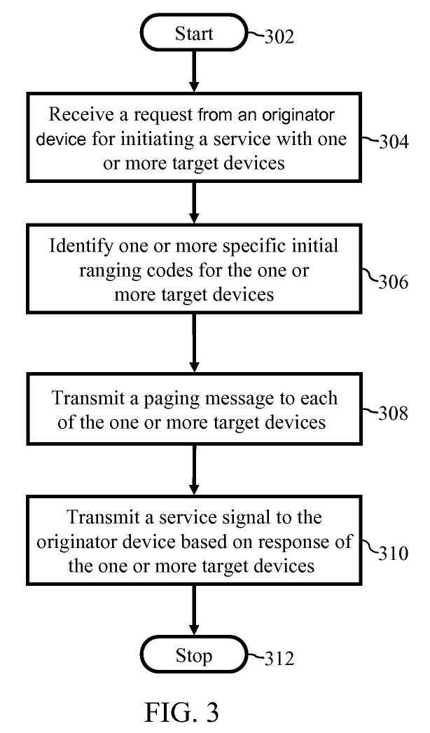

FIG. 3 is a flow diagram illustrating a method 300 for providing a service in the network 100, in accordance with an embodiment of the present invention. To describe the method 300, references will be made to FIG. 1 and FIG. 2, although it will be apparent that the method 300 can be implemented in any other suitable system. At step 302, the method 300 can be initiated. At step 304, a request for initiating a service with one or more target client devices, for example, client devices 104, 106, 108, and 110 can be received from an originator client device, for example, the client device 102, at a network device, for example, a BTS. Examples of the service can include, but are not limited to, a Push-To-Talk service (PTT) and a network gaming service. For one embodiment, the request can be received by the network device 112.

At step 306, one or more specific initial ranging codes can be identified for the one or more client devices 104, 106, 108, and 110. Further, each of the one or more specific initial ranging codes can be associated with each of the one or more client devices 104, 106, 108, and 110 and can have a specific interpretation. The specific interpretation of a specific initial ranging code can be an action associated with the specific initial ranging code. The action can be, for example, accepting or rejecting a service. For one embodiment, the identification of the one or more specific initial ranging codes can be performed when a load value of the network 100 is less than a predefined value. The load value of the network 100 can be determined by the network device 112 and can be compared with a predefined value of load. For one embodiment, the predefined value of load can be a threshold load value of the network 100. The predefined value of load can be determined based on, for example, a traffic condition of the network 100. For another embodiment, the identification of the one or more specific initial ranging codes can be performed when a previous location information and a probable location information of the one or more client devices 104, 106, 108, and 110 is known. In this embodiment, if the location of a target client device is the same as the location determined by the network device, by using the previous location information and the probable location information, then the target device can use the identified one or more specific initial ranging codes. For example, the previous location of the client device 104 can be, for example, the cell 204. Further, the probable location of the client device 104, calculated by the network device 112, can be, for example, the cell 206. Further, the client device 104 can be assigned the one or more specific initial ranging codes corresponding to the cells 204 and 206. Furthermore, if the client device 104 is in one of the cells 204 or 206, then the client device 104 can use the one or more specific initial ranging codes identified by the network device 112. However, if the client device 104 is in any other cell other than the cells 204 or 206, then the client device 104 can use either a random specific initial ranging code or a different initial ranging code.

For one embodiment, the identification of the one or more specific initial ranging codes can be performed when a client device of the one or more client devices 104, 106, 108, and 110 is invited for the service in which the client device is a required participant. A response is necessary from a required participant of a service in order to establish the service. For example, Tom can operate the client device 102, Marc can operate the client device 104 and Bob can operate the client device 106. Further, Tom might initiate a PTT service with Marc and Bob, in which Marc can be a required participant. Further, Tom can send a request to the network device 112 for initiating a service with the Marc and Bob. However, for one embodiment, one or more specific initial ranging codes can be identified only for the client device 104 and not for the client device 106, as the client device 104 is a required participant.

For another embodiment, the identification of the one or more specific initial ranging codes can be performed when the one or more client devices 104, 106, 108, and 110 are invited for the service in which response of at least one of the one or more client devices 104, 106, 108, and 110 is sufficient to initiate the service. In this embodiment, for example, Tom operates the client device 102 and wants to establish a PTT call with Marc, Bob, and Susanne. Marc can operate, for example, the client device 104, Bob can operate, for example, the client device 106, and Susanne can operate, for example, the client device 108. Tom can send a request to the network device 112 for initiating a service with the Marc, Bob, and Susanne. Further, if any one of Marc, Bob, or Susanne accepts the PTT call, the PTT call will be established. As presence of any one among Marc, Bob, and Susanne is sufficient to establish the PTT call, one or more specific initial ranging codes can be identified for the client devices 104, 106, and 108.

For one embodiment, the one or more specific initial ranging codes can be reserved for the one or more client devices 104, 106, 108, and 110 and have a specific interpretation. For example, a pre-assigned specific initial ranging code ‘01’ can be reserved for the client device 104. The specific interpretation of the specific initial ranging code ‘01’ can be, for example, accepting the PTT call. The client device 104 can accept the PTT call request by replying to the paging message sent by the network device 112 using the specific initial ranging code ‘01’. In case the client device 104 wants to reject the service request, the client device 104 can use, for example, a randomly selected initial ranging code or a different initial ranging code. For another embodiment, a group of specific initial ranging codes can be reserved for each of the one or more client devices 104, 106, 108, and 110. In this embodiment, for example, the client device 104, can be assigned a group of specific initial ranging codes including the specific initial ranging codes ‘11’ and ‘10’. The specific interpretation of the specific initial ranging code ‘11’ can be accepting the service and the specific interpretation of the specific initial ranging code ‘10’ can be rejecting the service. The client device 104 can accept the service by responding to the paging message using the specific initial ranging code ‘11’. Further, the client device 104 can reject the service by responding to the paging message using the specific initial ranging code ‘10’.

Further, at step 308, a paging message can be transmitted to each of the one or more client devices 104, 106, 108, and 110. The paging message can be transmitted in response to the request made by the client device 102. The paging message can be, for example, a location updating message. For one embodiment, the one or more specific initial ranging codes associated with each of the one or more client devices 104, 106, 108, and 110 can be embedded in the paging message and sent to each of the one or more client devices 104, 106, 108, and 110. In this embodiment, the one or more initial ranging codes can be sent after every second predefined time interval. For example, the client device 104 can be assigned a specific initial ranging code after every second predefined time interval, say after every 10 seconds. Further, for one embodiment, the second predefined time interval can be set by a service provider of the service. For another embodiment, one or more groups of specific initial ranging codes can be embedded in the paging message and sent to the each of the one or more client devices 104, 106, 108, and 110. In this embodiment, a different subset of the one or more group of specific initial ranging codes sent to the each of the one or more client devices 104, 106, 108, and 110 is used for a different time-slot.

For example, the client device 106 can be assigned a group of specific initial ranging codes including specific initial ranging codes ‘01’, ‘00’, ‘11’, ‘10’, ‘111’, and ‘110’. Each of the specific initial ranging codes assigned to the client device 106 can have a specific interpretation. The specific interpretation of the specific initial ranging code ‘01’ can be forwarding the PTT call to another client device. The specific interpretation of the specific initial ranging code ‘00’ can be rejecting the PTT call or any future PTT call. Further, the specific interpretation of the specific initial ranging code ‘11’ can be accepting the PTT call or any future PTT call and the specific interpretation of the specific initial ranging code ‘10’ can be transferring the PTT call to an answering machine. Further, the client device 106 can use the specific initial ranging codes ‘01’, ‘00’, ‘11’, and ‘10’, if the client device 106 responds within say, 10 seconds. However, if the client device 106 wants to respond after 10 seconds, it can do so by using specific initial ranging codes ‘111’ and ‘110’. The specific interpretation of the specific initial ranging code ‘111’ can be accepting the PTT call and the specific interpretation of the specific initial ranging code ‘110’ can be rejecting the PTT call. In this embodiment, the number of specific initial ranging codes available to the client device 106 reduces after every 10 seconds.

At step 310, a service signal can be transmitted to the client device 102 based on the response of the one or more client devices 104, 106, 108, and 110 within a first predefined time interval. For one embodiment, the first predefined time interval can be based a previous location information of a client device, a probable location information of the client device and/or a load value of the network 100. The service signal can be, for example, an approval signal, a rejection signal, or a no-response signal.

The approval signal is transmitted to the client device 102 when at least one of the one or more client devices 104, 106, 108, and 110 accepts the request for the PTT call within the first predefined time interval. The request can be accepted by at least one of the one or more client devices 104, 106, 108, and 110 by responding to the paging message using a specific initial ranging code. The specific interpretation of the specific initial ranging code, used for responding to the paging message, can be accepting the service. For one embodiment, when a client device is not in its last known cell or the cell where the client device was expected to be, then the acceptance message of the client device can include a randomly selected initial ranging code to accept the invitation for PTT service. In this embodiment, the last known cell of the client device can be determined by using the last known cell information stored at a network device, for example a BTS. The cell, where the client device is expected to be, can be determined by using the probable location information stored at the BTS. The acceptance message can also include processing capability information of the one or more client devices 104, 106, 108, and 110. The processing ability of a client device can be in terms of, for example, time taken by the client device to process certain request.

Further, the rejection signal can be transmitted to the client device 102 when each of the one or more client deices 104, 106, 108, and 110 rejects the request for the service within the first predefined time interval. For one embodiment, the rejection signal can be transmitted when a target client device which is required participant in the service rejects the request for the service. The request can be rejected by a client device by responding to the paging message using a specific initial ranging code. The specific interpretation of the specific initial ranging code, used for responding to the paging message, can be rejecting the service. Further, the rejection signal can be transmitted when a denial message is received from a client device within the first predefined time interval. For one embodiment, the denial message can include a pre-assigned specific initial ranging code assigned to the client device. For another embodiment, the denial message can include a randomly selected specific initial ranging code.

The no-response signal is transmitted to the client device 102 when no message is received from any of the one or more client devices 104, 106, 108, and 110 in response to the paging message within a first predefined time interval. For one embodiment, the no-response signal can be transmitted to the client device 102 when a target client device, which is a required participant in the PTT service request, either rejects the PTT service or does not responds to the PTT service request. At step 312, the method 300 is terminated.

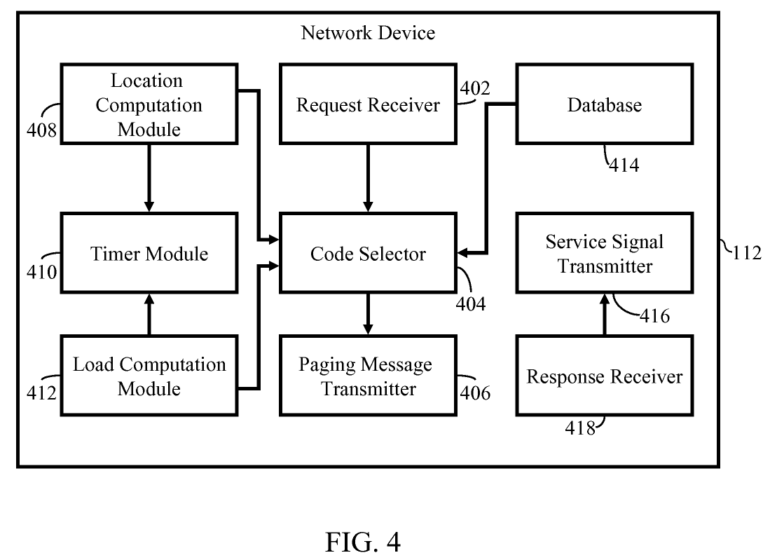

FIG. 4 illustrates a block diagram of the network device 112, in accordance with some embodiments of the present invention. Examples of network device 112 include, but are not limited to, an application server and a Base Transceiver Station (BTS). For one embodiment, the network device 112 can include a request receiver 402, a code selector 404, a paging message transmitter 406, a location computation module 408, a timer module 410, a load computation module 412, a database 414, a service signal transmitter 416 and a response receiver 418. Further, the request receiver 402 can receive a request from the client device 102 for initiating a service, for example, a PTT service, with one or more of the client devices 104, 106, 108, and 110. After the request receiver 402 has received the request for initiating the service from the client device 102, the code selector 404 can identify one or more specific initial ranging codes for the one or more client devices 104, 106, 108, and 110. Further, each of the one or more specific initial ranging codes is associated with each of the one or more client devices 104, 106, 108, and 110 and has a specific interpretation. The specific interpretation of a specific initial ranging code can be an action associated with the specific initial ranging code. The action can be, for example, accepting or rejecting a service.

For one embodiment, the code selector 404 can identify the one or more specific initial ranging codes when a load value of the network 100 is less than a predefined value. The load value of the network 100 is determined by the load computation module 412 and compared with the predefined value of load. The predefined value of load is determined based on, for example, traffic condition of the network 100.

For another embodiment, the code selector 404 can identify the one or more specific initial ranging codes when the previous location information and the probable location information of the one or more client devices 104, 106, 108, and 110 is known. The previous location information and the probable location information is determined by the location computation module 408. In this embodiment, if the previous location of the client device 104 was the cell 204 and the probable location of the client device 104 is also the cell 204, then a specific ranging code will be identified for the client device 104.

For yet another embodiment, the code selector 404 identifies the one or more specific initial ranging codes when a client device of the one or more client devices 104, 106, 108, and 110 is invited for the service in which the client device is a required participant. For yet another embodiment, the code selector 404 identifies the one or more specific initial ranging codes when the one or more client devices 104, 106, 108, and 110 are invited for the service in which response of at least one of the one or more client devices is sufficient to initiate the service.

Further, for one embodiment, the code selector 404 can randomly identify the one or more specific initial ranging codes, for the one or more client devices 104, 106, 108, and 110, from a set of specific initial ranging codes. For another embodiment, the code selector 404 can identify the one or more specific initial ranging codes for the one or more client devices 104, 106, 108, and 110 from the database 414. The database 414 can include a set of reserved specific initial ranging codes and a set of pre-assigned specific initial ranging codes associated with the one or more client devices 104, 106, 108, and 110.

Further, when the code selector 404 has identified the one or more specific initial ranging codes for the one or more client devices 104, 106, 108, and 110, the paging message transmitter 406 can transmit a paging message to each of the one or more client devices 104, 106, 108, and 110. The paging message can be, for example, a location updating message. For one embodiment, the one or more specific initial ranging codes can be embedded in the paging message and sent to each of the one or more client devices 104, 106, 108, and 110. In this embodiment, the one or more initial ranging codes can be sent after every second predefined time interval till a response from one or more client devices is received. For example, the client device 104 can be assigned a specific initial ranging code after every second predefined time interval, say after every 10 seconds. Further, the second predefined time interval can be set by, for example, a provider of the service. For another embodiment, one or more group of specific initial ranging codes can be embedded in the paging message and can be sent to each of the one or more client devices 104, 106, 108, and 110. In this embodiment, a different subset of the one or more group of specific initial ranging codes is used for a different time-slot for each of the one or more client devices 104, 106, 108, and 110. In this embodiment, the number of specific initial ranging codes available to the client device 108 reduces after every time-slot.

Further, after the paging message is sent to the one or more client devices 104, 106, 108, and 110, a response can be received from one or more of the client devices 104, 106, 108, and 110 within a first predefined time interval. The first predefined time interval can be determined by the timer module 410. The first predefined time interval is based on one or more of the previous location information of a client device, the probable location information of a client device and the load value of the network 100. Further, the response can be received at the response receiver 418. The response can include an acceptance message or a denial message. Based on the response obtained from one or more of the or more client devices 104, 106, 108, and 110, a service signal can be transmitted to the client device 102 by the service signal transmitter 416. Further, the service signal can be an approval signal, a rejection signal, or a no-response signal.

The approval signal is transmitted to the client device 102 by the service signal transmitter 416 when at least one of the one or more client devices 104, 106, 108, and 110 accepts the request for the PTT call within the first predefined time interval. For one embodiment, the approval signal can be a Talk-Permit-Tone (TPT) signal. The request can be accepted by at least one of the one or more client devices 104, 106, 108, and 110 by responding to the paging message using a specific initial ranging code. For another embodiment, an acceptance message is received from at least one client device of the one or more client devices 104, 106, 108, and 110 in response to the paging message within the first predefined time interval. The acceptance message can include the specific initial ranging code which has been assigned to the client device. For another embodiment, the acceptance message can include a randomly selected initial ranging code. For one embodiment, the acceptance message can include processing capabilities of the one or more client devices 104, 106, 108, and 110. The processing ability of a client device can be in terms of, for example, time taken by the client device to process certain request.

Further, the rejection signal can be transmitted to the client device 102 by the service signal transmitter 416 when each of the one or more client deices 104, 106, 108, and 110 rejects the request for the service within the first predefined time interval. The request can be rejected by each of the one or more client devices 104, 106, 108, and 110 by responding to the paging message using a specific initial ranging code. For another embodiment, the rejection signal is transmitted by the service signal transmitter 416 when a denial message is received from each of the one or more client devices 104, 106, 108, and 110 within the first predefined time interval. The denial message can include a pre-assigned specific initial ranging code assigned to the client device. For another embodiment, the denial message can include a randomly selected specific initial ranging code. Further, a rejection signal can also be transmitted when a denial message is received from a target client device which was a required participant in a PTT call.

Further, the no-response signal is transmitted to the client device 102 by the service signal transmitter 416 when no response is received from the one or more client devices 104, 106, 108, and 110 in response to the paging message within a first predefined time interval.

Various embodiments, as described above, provide a method and system for providing a service in the network. Further, the present invention reduces the time delay to transmit TPT. Furthermore, the present invention prevents falsing, as the TPT is available to the originator communication device after the link has been established between the originator and the target communication device. Consequently, the present invention prevents loss of communication due to falsing.

In the foregoing specification, the invention and its benefits and advantages have been described with reference to specific embodiments. However, one with ordinary skill in the art would appreciate that various modifications and changes can be made without departing from the scope of the present invention, as set forth in the claims below. Accordingly, the specification and figures are to be regarded in an illustrative rather than a restrictive sense, and all such modifications are intended to be included within the scope of the present invention. The benefits, advantages, solutions to problems, and any element(s) that may cause any benefit, advantage or solution to occur or become more pronounced are not to be construed as critical, required or essential features or elements of any or all the claims. The invention is defined solely by the appended claims, including any amendments made during the pendency of this application, and all equivalents of those claims, as issued.

What is claim is:

1. A method for providing a service in a network, wherein the network comprises an originator device, a network device, and one or more target devices, the method comprising:
receiving a request from the originator device for initiating the service with the one or more target devices;
identifying one or more specific initial ranging codes for the one or more target devices, wherein each of the one or more specific initial ranging codes is associated with each of the one or more target devices, and wherein identifying the one or more specific initial ranging codes is performed when at least one of the following conditions is true:
a load value of the network is less than a predefined value;
a previous location information and a probable location information of the one or more target devices is known;
a target device of the one or more target devices is invited for the service, wherein the target device is a required participant in the service; and
the one or more target devices are invited for the service, wherein response of at least one of the one or more target devices is sufficient to initiate the service;
transmitting a paging message to each of the one or more target devices, wherein the paging message is transmitted in response to the request made by the originator device; and
transmitting a service signal to the originator device based on response of the one or more target devices to the paging message within a first predefined time interval.

2. The method as recited in claim 1, wherein the service is selected from a group comprising a Push-To-Talk service and a network gaming service.

3. The method as recited in claim 1, further comprising determining the first predefined time interval based on one or more of the previous location information, the probable location information and the load value of the network.

4. The method as recited in claim 1, wherein transmitting the paging message further comprises sending the one or more specific initial ranging codes to the one or more target devices.

5. The method as recited in claim 4, wherein each of the one or more specific initial ranging codes has a specific interpretation.

6. The method as recited in claim 4, wherein the one or more specific initial ranging codes are sent after every second predefined time interval.

7. The method as recited in claim 1, wherein transmitting the paging message further comprises sending one or more groups of specific initial ranging codes to the one or more target devices.

8. The method as recited in claim 7, wherein each specific initial ranging code of the one or more groups of specific initial ranging codes has a specific interpretation.

9. The method as recited in claim 8, wherein a different subset of the one or more groups of specific initial ranging codes sent to the one or more target devices is used for a different timeslot.

10. The method as recited in claim 1 further comprising reserving each of the one or more specific initial ranging codes for the one or more target devices.

11. The method as recited in claim 1, wherein the service signal is selected from a group comprising an approval signal, a rejection signal and a no-response signal.

12. The method as recited in claim 11 further comprising transmitting the approval signal to the originator device when an acceptance message is received from at least one target device of the one or more target devices in response to the paging message within the first predefined time interval.

13. The method as recited in claim 12, wherein the acceptance message comprises one of the specific initial ranging code and a randomly selected initial ranging code based on location of the one or more target devices.

14. The method as recited in claim 12, wherein the acceptance message comprises processing capability information of the one or more target devices.

15. The method as recited in claim 11, wherein transmitting the service signal further comprises transmitting the rejection signal to the originator device when a denial message is received from each of the one or more target devices in response to the paging message within the first predefined time interval.

16. The method as recited in claim 15, wherein the denial message comprises one of a randomly selected initial ranging code and a pre-assigned initial ranging code associated with the one or more target devices.

17. The method as recited in claim 11, wherein transmitting the service signal further comprises transmitting the no-response signal to the originator device when no message is received from each of the one or more target devices in response to the paging message within the first predefined time interval.

18. A network device comprising:
a request receiver for receiving a request for initiating a service from an originator device;
a code selector for identifying one or more specific initial ranging codes for one or more target devices, wherein each of the one or more specific initial ranging codes is associated with each of the one or more target devices and wherein identifying the one or more specific initial ranging codes is performed when at least one of the following conditions is true:
a load value of the network is less than a predefined value;
a previous location information and a probable location information of the one or more target devices is known;
a target device of the one or more target devices is invited for the service, wherein the target device is a required participant in the service; and
the one or more target devices are invited for the service, wherein response of at least one of the one or more target devices is sufficient to initiate the service;
a paging message transmitter for transmitting a paging message to each of the one or more target devices, wherein the paging message is transmitted in response to the request made by the originator device; and
a service signal transmitter for transmitting a service signal to the originator device based on response of the one or more target devices to the paging message within a first predefined time interval.

19. The network device as recited in claim 18, wherein the network device is a Base Transceiver Station (BTS).

20. The network device as recited in claim 18 further comprising a location computation module for determining one or more of the previous location information and the probable location information prior to identifying one or more specific initial ranging codes for the one or more target devices.

21. The network device as recited in claim 18 further comprising a timer module for determining a first predetermined time interval, wherein the first predefined time interval is based on one or more of the previous location information, the load value and the probable location information.

22. The network device as recited in claim 18 further comprising a load computation module for determining the load value of the network.

23. The network device as recited in claim 18 further comprising a database, wherein the database comprises a set of reserved initial ranging codes and a set of pre-assigned initial ranging codes associated with the one or more target devices.
